(19) United States
(12) Patent Application Publication
(10) Pub. No.: US 2016/0337323 A1
(43) Pub. Date: Nov. 17, 2016

(54) ENCRYPTION, DECRYPTION, AND TRIGGERED DELIVERY OF FILES

(71) Applicants: Michael Theodore Lester, Prior Lake, MN (US); Sahar Mohammed Ismail, Prior Lake, MN (US)

(72) Inventors: Michael Theodore Lester, Prior Lake, MN (US); Sahar Mohammed Ismail, Prior Lake, MN (US)

(21) Appl. No.: 15/220,918

(22) Filed: Jul. 27, 2016

Related U.S. Application Data
(62) Division of application No. 14/285,961, filed on May 23, 2014.

(51) Int. Cl. H04L 29/06; G06F 21/62

(52) U.S. Cl. CPC H04L 63/0428; G06F 21/6218; H04L 63/0876

(57) ABSTRACT

Encrypting information includes receiving a question/answer pair, generating a file pass phrase, encrypting the file with the file pass phrase, normalizing the answer, encrypting the file pass phrase with the normalized answer, creating a hash of the normalized answer; delivering encrypted information includes alerting the recipient of the encrypted file to be downloaded, providing the recipient with questions associated with the encrypted file, normalizing answers provided by the recipient, creating a hash of the normalized answers, comparing the hash to stored hashes associated with the encrypted file, allowing download of the encrypted file when a predetermined number of the stored hashes match the normalized hashes; and storing and triggering delivery of encrypted information to a recipient includes storing encrypted information about a recipient, determining a triggering event associated with the encrypted information, delivering to the recipient an invitation to retrieve the encrypted information upon occurrence of the triggering event.

### CROSS-REFERENCE TO RELATED APPLICATION(S)

This application is a Divisional Application of U.S. patent application Ser. No. 14/285,961, filed on May 23, 2014, the disclosure of which is incorporated by reference in its entirety.

### FIELD

The present disclosure relates generally to encryption and storage of information and in particular the present disclosure relates to delivery of encrypted information on occurrence of a triggering event.

### BACKGROUND

Many individuals desire to have information delivered to another party upon occurrence of a specific event. Such events could be, for example, a known date such as a birthday, anniversary, or a specific date with other relevance. Many individuals desire to have information released when a specific event occurs, but do not know with certainty when the event will in fact occur. Such events could be, for example, death of the individual, incapacitation of the individual, disappearance of the individual, and the like.

Information to be delivered to another party upon occurrence of a specific event such as those described herein may be routine, such as the delivery of a birthday or anniversary greeting, or more important, such as documents like wills, trusts, bonds, financial/account information, marriage certificates, adoption papers, or other important papers. In some instances, an individual storing information may not want the ultimate recipient to be aware of, or have access to, the information prior to the occurrence of a specific event.

Since certain events by their very nature restrict or preclude the individual from performing delivery of documents or other information personally, and since the specific event may be many years after generation of the information, it is desirable to secure storage of the information such that it is secure from all entities other than the intended recipient. This is also true because some information of the type discussed herein may be personal and sensitive.

Strong encryption is only secure if the keys for such encryption are also secure, or unknown to a potential hacker. Some encryption can be broken by brute force, but the stronger the encryption, the more difficult it is to break by brute force. Many encryption methods for use by the public use a two key system such as a two-key, public/private key system. In such a system, something encrypted with a public key can only be decrypted using the private key and something encrypted using the private key can only be decrypted using the public key. The public key is published so that anyone can access it. The private key is kept privately and should be available only to the owner of the key.

Therefore, one way to ensure that a message or file originates with a specific entity, is to decrypt it by a public key. This is sufficient to show that the message or file was encrypted with the specific private key, at least reasonably assuring the decrypting party that the file or message originated with the holder of the private key. One way to ensure that a message or file can only be decrypted by a specific entity, is to encrypt it with the public key for the specific entity. Then, only the holder of the private key may decrypt the message encrypted with the available public key.

There are a number of drawbacks to a public/private key system. For example, the private key could be compromised by copying the private key from an individual's computer; the private key could be lost thereby rendering all information encrypted using the public key worthless and unable to be decrypted, or the private key could be destroyed by a catastrophic data loss.

Further, if a holder of a private key of a public/private key system wishes a third party to be able to decrypt information encrypted with the public key, the holder must make the private key available, potentially compromising the private key.

For the reasons stated above, and for other reasons stated below which will become apparent to those skilled in the art upon reading and understanding the present specification, there is a need in the art for improved encryption and delivery of information on occurrence of a triggering event.

### BRIEF DESCRIPTION OF DRAWINGS

FIG. 1 is a flow chart diagram of an embodiment of the present disclosure;

FIG. 2 is a flow chart diagram of another embodiment of the present disclosure;

FIG. 3 is a flow chart diagram of yet another embodiment of the present disclosure; and

FIG. 4 is a flow chart diagram of another embodiment of the present disclosure; and

FIG. 5 is a diagram of a computer system on which embodiments of the disclosure may be practiced.

### DETAILED DESCRIPTION

In the following detailed description of the embodiments, reference is made to the accompanying drawings that form a part hereof. In the drawings, like numerals describe substantially similar components throughout the several views. These embodiments are described in sufficient detail to enable those skilled in the art to practice the invention. Other embodiments may be utilized and structural changes may be made without departing from the scope of the present invention.

The following detailed description is, therefore, not to be taken in a limiting sense, and the scope of the present disclosure is defined only by the appended claims, along with the full scope of equivalents to which such claims are entitled.

In one or more embodiments, methods for encrypting information for storage and later delivery are provided. In some such embodiments, the holder of the encrypted information does not possess an ability to decrypt the information.

In one or more other embodiments, the existence of stored encrypted information and the information itself may be delivered to a recipient when a life event for a subscriber occurs. In such embodiments, the recipient need not be aware of the existence of the encrypted information before the life event for the subscriber occurs.

The file or files to be encrypted may be any digital content. The information may be text, images, documents, digital pictures, digital video, digital audio, etc., or any combination thereof. While the term “file” is used, it should be understood that “file” may incorporate multiple files of one or more types, including but not limited to those described herein.

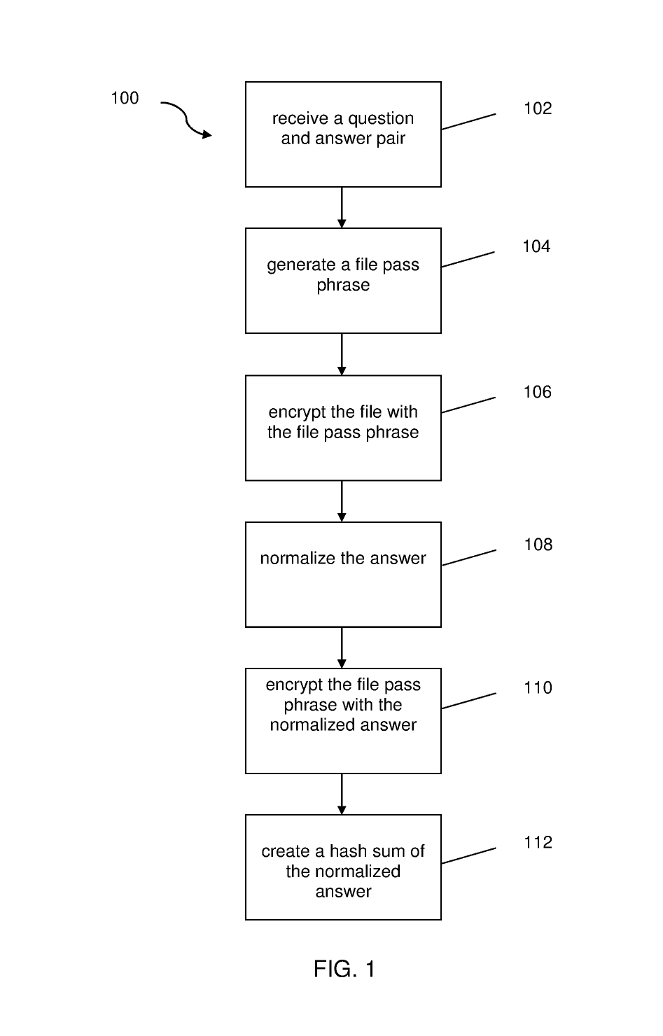

A method 100 of encrypting a file is shown in flow chart form in FIG. 1.

Method 100 comprises, in one embodiment, receiving a question and answer pair in block 102, generating a file pass phrase in block 104, encrypting the file with the file pass phrase in block 106, normalizing the answer in block 108, encrypting the file pass phrase with the normalized answer in block 110, and creating a hash sum of the normalized answer in block 112.

Encryption and delivery each rely in one embodiment on a shared secret, that is, a piece of knowledge possessed by each of a subscriber and an intended recipient. A shared secret could be something like:

“Where were we the first time we kissed?”

“What did you call your pet stuffed monkey as a kid?”

“What name did we secretly use to refer to my uncle Bob?”

“When we were camping in California, what did we forget to bring with us that we desperately needed?”

To increase a likelihood of match when both a subscriber and a recipient enter the answer to a shared secret, all answers are normalized in one embodiment. Normalization is used to remove at least some potential issues with grammar and punctuation. In one embodiment, normalization converts all characters to lower case, and removes non-alphanumeric characters, punctuation, and spacing. Therefore, “Mom's house” normalizes to “momshouse” and “The 3^{rd} level of the house!” normalizes to “the3rdlevelofthehouse”. It should be understood that different normalization methods are amenable to use with the embodiments of the present disclosure, and are within the scope of the disclosure. Subscribers and recipients are in one embodiment offered instructions on being specific enough that answers to questions should match shared remembrance closely, so as to take one or only a few attempts on the part of the recipient to achieve an answer match.

A hash sum is a numerical value that is derived mathematically from a pass phrase. Two unique features of a hash sum are that it creates a fixed length value regardless of the length of the pass phrase, and it is a deterministic one-way process. The first feature means that a 256 bit hash function will create a 256 bit hash sum regardless of the length of the pass phrase. The second feature means that given the same pass phrase and the same hash function, the same pass phrase will always produce the same hash sum, but it is impossible to run a hash function backwards and determine the pass phrase by starting with the hash sum.

A file pass phrase is in one embodiment generated using a random generation function. The file pass phrase is used to encrypt the file. Once the file is encrypted with the file pass phrase, the file pass phrase is itself encrypted using the normalized answer(s) to the shared secred question and answer pair(s) as the pass phrase to encrypt the file pass phrase. This generates an encrypted file pass phrase.

The encrypted file, the encrypted file pass phrase, the hash sum of the normalized answer, and the question are uploaded in one embodiment to a computer from an external location, such as an external computer, for storage. Delivery of the encrypted file is discussed later herein.

In one embodiment, the unencrypted file pass phrase exists only in volatile memory at the time of generation of the file pass phrase. Following an uploading of the encrypted file, the encrypted pass phrase(s), the hash sum of the normalized answer(s), and the question(s), the encrypted file, the encrypted pass phrase(s), the question and answer pair(s), the hash sum(s), and the file pass phrase are securely deleted so the only storage of the data is at an external server. This data, because of the encryption method, is secured in multiple ways, and the holder of the data does not possess the proper information to decrypt the encrypted information. In part, this is because the actual file pass phrase is not transmitted to the external server and thus cannot be compromised either in transmission or storage, and the answer to the question of the question and answer pair is not transmitted to the external server. Instead, only a hash of the normalized answer is delivered to the external server.

The use of the file pass phrase to encrypt the file, and the subsequent second layer of encryption using the normalized answers to create the encrypted file pass phrase allows the originator of the file to later change the question and answer pair(s) without requiring the actual file to be re-transmitted to the holder of the file. In order to change one or more questions and answer pairs, a correct normalized answer is used to decrypt one of the encrypted pass phrases to obtain the file pass phrase in clear text. Then, new question and answer pair(s) are provided, and the file pass phrase is re-encrypted with the new normalized answer(s) as described herein.

While a single question and answer pair are described above, it should be understood that to provide even more secure encryption and protection, in one embodiment a plurality of question and answer pairs are received. A user may specify, given the plurality of question and answer pairs, that two or more questions must be answered by a potential recipient before encrypted information is delivered to the recipient. In an embodiment using more than one question and answer pair, all combinations of answer pairs are determined. Combinations include individual answers plus pairings (or more) without regard for order. So, for a set containing elements A, B, and C, the combinations of two elements are AB, AC, and BC, and the combination of three elements is ABC. With each single elements as a “combination” of one, there are therefore seven possible combinations given a three element set of A, B, and C. Those combinations are A, B, C, AB, AC, BC, and ABC.

When a plurality of question and answer pairs are received, each answer of the plurality of question and answer pairs is normalized as discussed above. Then, combinations of the normalized answers are created. For example, if three question and answer pairs are provided, each answer is normalized, and combinations of answers are generated. For combinations of more than one answer, the answers are concatenated in order of the received question/answer pairs. Therefore, if there are three answers, “Red”, “Green”, and “Blue”, the normalized answers are “red”, “green”, and “blue” and the combinations are “red”, “green”, “blue”, “redgreen”, “redblue”, “greenblue”, and “redgreenblue”. In this embodiment, the file pass phrase is encrypted using each normalized combination, one at a time, to generate in this embodiment seven encrypted pass phrases.

In one embodiment, the method receives a specification as to how many of the questions are to be answered in order for a recipient to receive the encrypted file. For example, an answer to any one of the three questions may be sufficient; two of three answers may be sufficient; or all three answers must be provided. Since each combination of the normalized answers is used to generate its own encrypted file pass phrase, multiple recipients can be given different answer requirements for the same encrypted file.

In another embodiment, more than one question and answer pair may be provided such that each of two or more individuals know one answer, and therefore more than one individual recipient is required to generate the proper answers to allow downloading and decryption of an encrypted file.

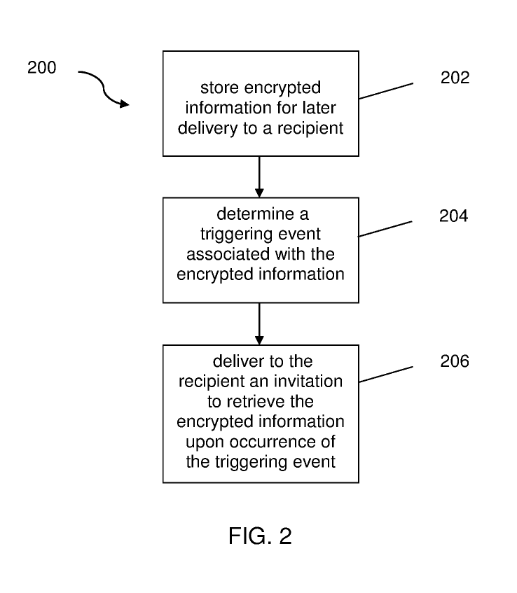

A method 200 for delivery of an encrypted file is shown in flow chart form in FIG. 2. Method 200 comprises, in one embodiment, storing encrypted information for later delivery to a recipient in block 202, determining a triggering event associated with the encrypted information in block 204, and delivering to the recipient an invitation to retrieve the encrypted information upon occurrence of the triggering event in block 206.

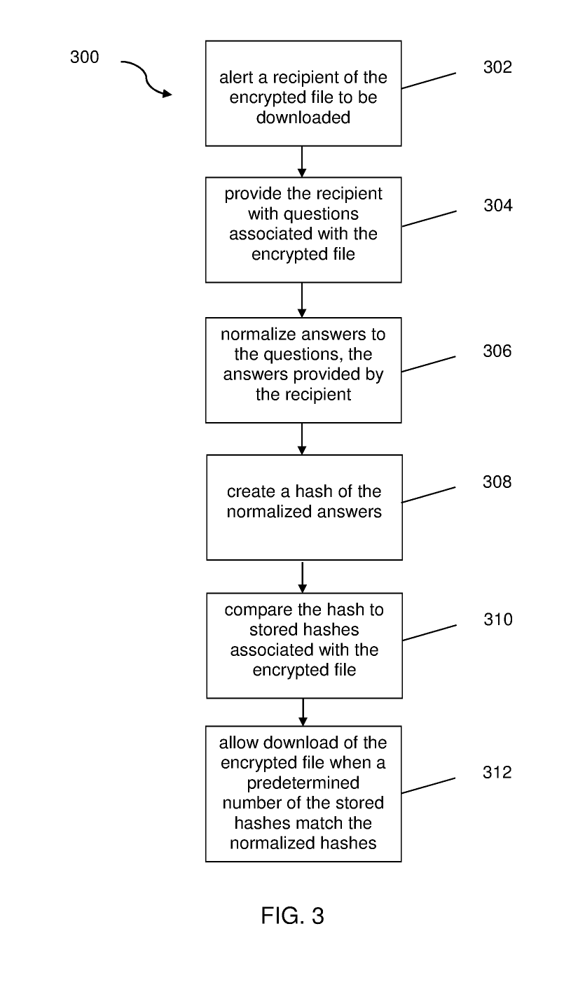

A method 300 for alerting a potential recipient of an encrypted file to be downloaded, and the downloading of the file, is shown in flow chart form in FIG. 3. Method 300 comprises, in one embodiment, alerting a recipient of the encrypted file to be downloaded in block 302, providing the recipient with questions associated with the encrypted file in block 304, normalizing answers provided by the recipient in block 306, creating a hash of the normalized answers in block 308, comparing the hash to stored hashes associated with the encrypted file in block 310, and allowing download of the encrypted file when a predetermined number of the stored hashes match the normalized hashes in block 312.

Decryption of the encrypted file, once downloaded, is accomplished in one embodiment as follows. The encrypted file pass phrase associated with the file is downloaded with the encrypted file. Decryption is performed on the encrypted file pass phrase using the answer or answers provided by the user, normalized as described above. The resulting decrypted file pass phrase is used to decrypt the encrypted file.

In one embodiment, the recipient answers are hashed at a recipient's local machine so that at no time are answers transmitted in the clear. Only hash sums representing the answers are transmitted.

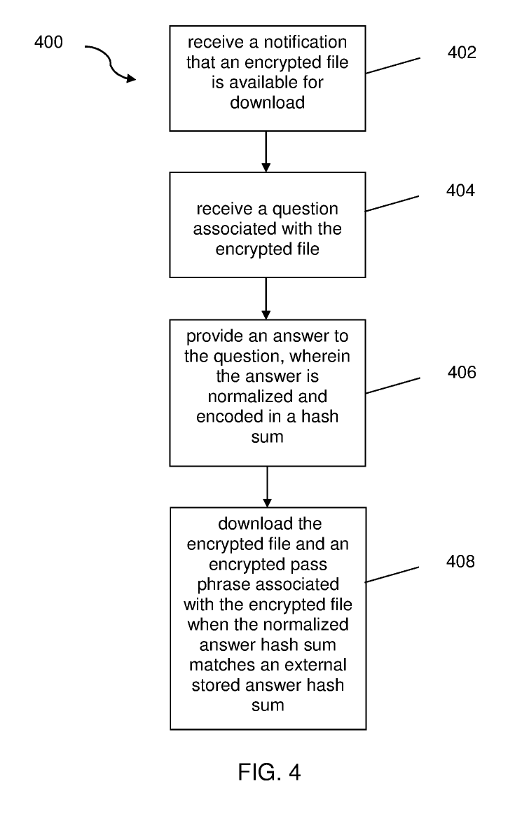

A method 400 of downloading and decrypting an encrypted file is shown in flow chart form in FIG. 4. Method 400 comprises, in one embodiment, receiving a notification that an encrypted file is available for download in block 402, receiving a question associated with the encrypted file in block 404, providing an answer to the question, wherein the answer is encoded in a hash sum in block 406, and downloading the encrypted file and an encrypted pass phrase associated with the encrypted file when the answer hash sum matches an external stored answer hash sum in block 408.

Delivery, or attempted delivery, is contingent in one embodiment upon the occurrence of a triggering event or events. Such event or events may be simple, or more complex. Simple triggering occurs on a determination that an event has taken place that should trigger the delivery of the information stored on the site. Simple triggering includes, for example, the arrival of a certain date and time. More complex triggering includes, for example, the cessation of an electronic heartbeat or the confirmed death of a subscriber. Details of example triggering are discussed below.

A Date-Time trigger in one embodiment is simply the arrival of a specific date and time. In one embodiment, a message may be sent to the subscriber who originated the file to be delivered, warning the subscriber that the date-time is approaching, and that unless intervention is taken, the package of information will be delivered. This trigger could also be used to trigger other messages such as “Happy Birthday,” “Happy Anniversary,” a reminder to renew a health care directive, or anything of that nature.

One inevitable life event that is used as a triggering event is the death of a subscriber. This event is frequently when a subscriber may desire that information in the form of an encrypted file be released to a third party. The determination of this life event can be problematic from a direct point of view, but can be accomplished programmatically from tangential events. One method for determining the death of a subscriber is the termination of access to a billing account used to maintain a subscriber account. Typically, accounts are frozen on the death of the account holder, so a terminated or frozen account is used in one embodiment as a triggering event.

Such a termination can be due to neglect or other circumstances, and as such, in one embodiment, termination of an account triggers a contact attempt or attempts with the subscriber to determine whether a true triggering event has occurred. In one embodiment, a broadcast message may be sent to the available contact options for the account with a message that unless the subscriber logs into the account within a certain time period, the system will assume that the subscriber is not alive or available and the encrypted file will be delivered. The time period for this secondary validation is configurable by the subscriber. Further, the user is able to elect an option to bypass or shorten the time period with an alternate validation. An example of this might be that a subscriber may be traveling or otherwise not available for communication for a given period of time. If an account fails, a subscriber can have a validation time limit set to be outside of the amount of time that the subscriber anticipates being unavailable. Alternatively, a tiered hierarchy for contact may be used, with attempted contact by one method, and if that is not answered, attempted contact by a second, third, etc. . . . method.

Other options for verifying death of a subscriber include consulting the United States Social Security Death Index (SSDI), or the forwarding of a death certificate to the holder of the encrypted file. The SSDI is not perfectly reliable, and further, may take some time before an update is made. Therefore, for more time sensitive information, relying on the SSDI may not be feasible.

In another embodiment, a triggering event is based on a digital heartbeat. A triggering event based on a digital heart beat includes a regular contacting of the subscriber via one or more media. For example, a system of monitoring a digital heart beat will “ping” a subscriber using one or more methods determined by the subscriber, with a message to which the subscriber must respond to maintain the digital heartbeat. A response to the ping message creates a digital heart beat to confirm to the holder of the encrypted file that the subscriber is still alive, well, and in control of their faculties. Examples of ping messages can include instructions for the reply, or be completely benign with only the subscriber knowing that a reply is needed. Likewise, a simple reply of any text could be sufficient, or a predetermined pass phrase may be used. In addition, to determine whether a subscriber is capable of responding, but is under duress, there may be two replies stored by the holder, with one that is interpreted as a bona fide reply, and one that looks like a bona fide reply, but in reality is an indication that the person is under duress, triggering an attempted delivery to the intended recipient.

In one embodiment, a series of cascading digital heartbeats are used to determine if a triggering event has occurred. For example, a primary heartbeat is used. The primary heartbeat can be passive such as the successful charging of a credit card, or it can be active such as an email or text message that is sent to the subscriber, and to which the subscriber must respond. If either of these methods results in a failed status for a predetermined period, a secondary avenue of communication can be used to attempt to contact the subscriber. If this secondary communication is successful, the subscriber is directed to correct any issues there may have been with the primary heartbeat (such as an expired credit card) and then the heartbeat resumes. If the secondary communication is unsuccessful, the triggering event is considered completed and the recipient is notified that there is information waiting for them.

Once a triggering event is verified, a recipient or recipients are notified of the existence of both the triggering event and the encrypted file, and the methods described above are employed for verification, downloading, and eventual decryption.

A delivery method according to one embodiment alerts a potential recipient that there is a file or files for download from the holder. This notification may be via electronic communication such as electronic mail or text message, or by more traditional methods including telephone and mail, since under circumstances in which a triggering event has occurred, a potential recipient may consider as spam an unexpected message from an unknown source.

The notification may in one embodiment contain a personalized message from the subscriber to assure the recipient that the message is valid and not junk mail or spam. In one embodiment, a web address is provided for logging in to the site of the holder of the encrypted file. The recipient may then be shown a personal message from the subscriber again along with a short description of the service provided by the holder, so that the recipient understands the nature and purpose of the website.

Various examples of the present disclosure may be embodied in a computer program product, which may include computer readable program code embodied thereon, and the code executable to implement a method of encrypting or decrypting a file. The computer readable program code may take the form of machine-readable instructions. These machine-readable instructions may be stored in a memory, such as a computer-usable medium, and may be in the form of software, firmware, hardware, or a combination thereof. The machine-readable instructions configure a computer to perform various methods of thread balancing and allocation, such as described herein in conjunction with various embodiments of the disclosure.

In a hardware solution, the computer-readable instructions are hard coded as part of a processor, e.g., an application-specific integrated circuit (ASIC) chip. In a machine-readable instruction solution, the instructions are stored for retrieval by the processor. Some additional examples of computer-usable media include static or dynamic random access memory (SRAM or DRAM), read-only memory (ROM), electrically erasable programmable ROM (EEPROM or flash memory), magnetic media and optical media, whether permanent or removable. Most consumer-oriented computer applications are machine-readable instruction solutions provided to the user on some form of removable computer-usable media, such as a compact disc read-only memory (CD-ROM) or digital video disc (DVD). Alternatively, such computer applications may be delivered electronically, such as via the Internet or the like.

It will be appreciated that embodiments of the present disclosure can be realized in the form of hardware, machine-readable instructions, or a combination of hardware and machine-readable instructions. Any such set of machine-readable instructions may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement embodiments of the present disclosure. Accordingly, embodiments provide a program comprising code for implementing a system or method and a machine readable storage storing such a program. Still further, embodiments of the present disclosure may be conveyed electronically via any medium such as a communication signal carried over a wired or wireless connection and embodiments suitably encompass the same.

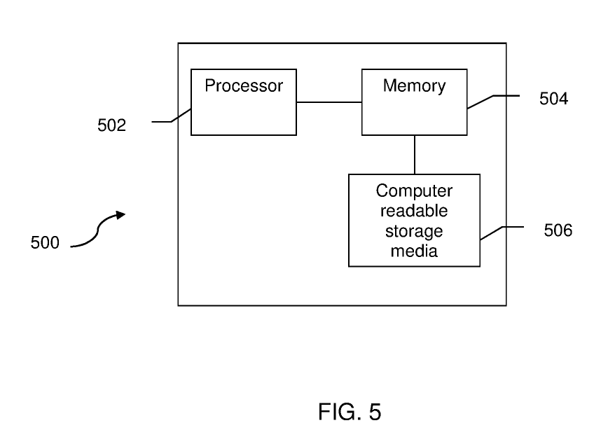

FIG. 5 is a representation of a computer system 500 for use with various embodiments of the disclosure. The computer system 500 includes a processor 502 connected to and capable of communication with a computer readable memory 504 which may include volatile and non-volatile memory. Computer-readable storage medium 506 is in communication with system 500.

Computer-readable storage media in various embodiments may include different forms of memory or storage, including by way of example semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs).

Computer-readable storage media can be internal or external to the system 400, and in various embodiments contains a computer program product having machine-readable instructions stored thereon adapted to cause the processor 502 to perform one or more methods described above with respect to FIGS. 1-4.

### CONCLUSION

Methods for encrypting files, decrypting files, and triggering delivery of encrypted files have been shown. One method of encrypting a file includes receiving a question and answer pair, generating a file pass phrase, encrypting the file with the file pass phrase, normalizing the answer, encrypting the file pass phrase with the normalized answer, and creating a hash of the normalized answer. One method of delivering an encrypted file to a recipient for decryption includes alerting the recipient of the encrypted file to be downloaded, providing the recipient with questions associated with the encrypted file, normalizing answers provided by the recipient, creating a hash of the normalized answers, comparing the hash to stored hashes associated with the encrypted file, and allowing download of the encrypted file when a predetermined number of the stored hashes match the normalized hashes. One method of storing and triggering delivery of encrypted information to a recipient includes storing encrypted information for a recipient, determining a triggering event associated with the encrypted information, and delivering to the recipient an invitation to retrieve the encrypted information upon occurrence of the triggering event.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof. Although elements have been shown or described as separate embodiments above, portions of each embodiment may be combined with all or part of other embodiments described above. Elements may appear in different orders in some embodiments without departing from the scope of the disclosure.

What is claimed is:

1. A method of encrypting a file, comprising:
receiving a question and answer pair;
generating a file pass phrase;
encrypting the file with the file pass phrase;
normalizing the answer;
encrypting the file pass phrase with the normalized answer; and
creating a hash of the normalized answer.

2. The method of claim 1, and further comprising:
uploading the encrypted file, the encrypted file pass phrase, the hash of the normalized answer, and the question from an external location.

3. The method of claim 2, and further comprising securely deleting the question and answer pair, the hash of the normalized answer, the encrypted file pass phrase, and the encrypted file.

4. The method of claim 1, wherein receiving a question and answer pair comprises receiving a plurality of question and answer pairs, and further comprising:
normalizing each answer of the plurality of question and answer pairs;
generating normalized answer combinations for each of the answers and for each combination of the plurality of answers; and
encrypting the file pass phrase with each of the normalized answers and each combination of the plurality of normalized answers.

5. The method of claim 4, wherein the unencrypted file pass phrase exists only in volatile memory.

6. The method of claim 1, wherein the unencrypted file pass phrase exists only in volatile memory.

7. The method of claim 1, and further comprising receiving information on a recipient for later delivery of the encrypted file.

8. The method of claim 1, and further comprising receiving information on a trigger event to trigger delivery of the encrypted file to a recipient.

9. A method of storing and triggering delivery of encrypted information to a recipient, comprising:
storing encrypted information for later delivery to the recipient;
determining occurrence of a triggering event associated with the encrypted information; and
delivering to the recipient an invitation to retrieve the encrypted information upon occurrence of the triggering event.

10. The method of claim 17, wherein determining occurrence of the triggering event comprises at least one of verifying death of an originator of the encrypted information, loss of a digital heartbeat of the originator of the encrypted information, and arrival of a date specified by the originator of the encrypted information.

11. The method of claim 17, wherein storing encrypted information comprises:
receiving a question and answer pair;
generating a file pass phrase;
encrypting the file with the file pass phrase;
normalizing the answer;
encrypting the file pass phrase with the normalized answer; and
creating a hash of the normalized answer.

12. The method of claim 19, and further comprising:
uploading the encrypted file, the encrypted file pass phrase, the hash of the normalized answer, and the question from an external location.

13. The method of claim 19, and further comprising securely deleting the question and answer pair, the hash of the normalized answer, the encrypted file pass phrase, and the encrypted file.

14. The method of claim 19, wherein receiving a question and answer pair comprises receiving a plurality of question and answer pairs, and further comprising:
normalizing each answer of the plurality of question and answer pairs;
generating normalized answer combinations for each of the answers and for each combination of the plurality of answers; and
encrypting the file pass phrase with each of the answers and each combination of the plurality of answers.

15. The method of claim 19, wherein the unencrypted file pass phrase exists only in volatile memory.

16. The method of claim 19, and further comprising providing identifying information about a recipient for later delivery of the encrypted file.

17. A method of encrypting a file, comprising:
generating a question and answer pair;
generating a file pass phrase;
encrypting the file with the file pass phrase;
normalizing the answer;
encrypting the file pass phrase with the normalized answer; and
creating a hash of the normalized answer.

18. The method of claim 25, and further comprising securely deleting the question and answer pair, the hash of the normalized answer, the encrypted file pass phrase, and the encrypted file.

19. A computer program product, comprising a computer usable medium having a computer readable program code embodied therein, the computer readable program code adapted to implement a method for encrypting a file, comprising receiving a question and answer pair, generating a file pass phrase, encrypting the file with the file pass phrase, normalizing the answer, encrypting the file pass phrase with the normalized answer, and creating a hash of the normalized answer.

20. A computer system, comprising:
a processor;
a memory; and
a computer program product, comprising a computer usable medium having a computer readable program code embodied therein, the computer readable program code adapted to implement a method for encrypting a file, comprising receiving a question and answer pair, generating a file pass phrase, encrypting the file with the file pass phrase, normalizing the answer, encrypting the file pass phrase with the normalized answer, and creating a hash of the normalized answer.
